(19) United States
(12) Patent Application Publication
(10) Pub. No.: US 2010/0144409 A1
(43) Pub. Date: Jun. 10, 2010

(54) SLIDING TYPE HANDHELD MOBILE DEVICE WITH GREAT SLIDING RANGE

(76) Inventors: Ming-Shuo Huang, Taipei (TW); Chi-Cheng Liao, Taipei (TW); Cheng-Yu Lin, Taipei (TW)

Correspondence Address: Dr. BANGER SHIA;Patent Office of Bang Shia, 102 Lindencrest Ct., Sugar Land, TX, 77479-5201, US

(21) Appl. No.: 12/628,318

(22) Filed: Dec. 1, 2009

(30) Foreign Application Priority Data
Dec. 10, 2008 (TW) 097147935

(51) Int. Cl. H04M 1/00

(52) U.S. Cl. 455/575.4

(57) ABSTRACT

A sliding type handheld mobile device is disclosed. A screen module covers a plurality of keys of a body, and may slide relative to the body to expose the keys. The screen module has an opening to allow the FPC to pass through and connect to the body. One end of a linkage is connected to the body, and another end is connected to a shuttle to make the linkage driven by the body and push the shuttle to cover the opening. This may prevent electronic components inside the screen module from being exposed.

### BACKGROUND OF THE INVENTION

1. Field of the Invention

The inventions relates to a sliding type handheld mobile device, and more particularly, to a sliding type handheld mobile device with a great sliding stroke.

2. Description of the Related Art

A mobile phone as a handheld communication device is quite popular nowadays. Generally, considering the appearance, there are three types of the mobile phones, bar type phones, flip type phones and slide type phones. The bar type phone is designed to be bar-shaped, and therefore it has a low manufacturing cost and is popular in the market. However, if both the keyboard and the screen in a bar type phone are considered, the bar type phone will form big volume. In addition, to prevent unintentional touch, the bar type phone should be designed with a keypad lock, which is inconvenient in use.

The flip type phone is improved over the bar type phone. When the flip type phone is folded, its volume is small. In addition, the flip type phone may have a bigger display screen, and a keypad lock is not needed. However, the connecting mechanism of the flip type phone is complex, and thus the manufacturing cost is high. The slide type phone has the advantages of both the bar type phone and the flip type phone, and it does not need a keypad lock and does not have big volume when it is unused. In addition, the design difficulty of the sliding mechanism and the manufacturing cost are not as much as the flip type phone.

To increase the number of keys, the slide type phone should be designed with a great sliding stroke to meet the demand. As shown in FIG. 1 and FIG. 2, the slide phone 10 includes a screen module 11 and a body 12. The screen module 11 may be stacked with the body 12 and cover keys 13 to achieve the minimum volume state (as shown in FIG. 1). In addition, the screen module 11 also may slide relative to the body 12 to expose the keys 13 and allow the user to operate (as shown in FIG. 2).

To provide more keys, the sliding stroke of the screen module 11 relative to the body 12 should be increased to decrease the overlapping area of the screen module 11 and the body 12 after the screen module slides. Generally, the screen module 11 is electrically connected to the body 12 by a connecting unit 14 such as a flexible printed circuit (FPC). To hide the FPC 14 and an opening 15 at the back of the screen module 11 which allows the connecting unit 14 to pass through, a shuttle 16 should be disposed additionally. When the screen module 11 slides relative to the body 12, the opening 15 and the connecting unit 14 are covered to prevent the connecting unit 14 or other inside elastic elements from being exposed.

To drive the shuttle 16 to slide, a linkage mechanism should be designed additionally. However, with the increase of the sliding stroke, the linkage mechanism is hard to design. A constrained motion mechanism should be used to constrain the freedom of motion of the shuttle 16. This may ensure that the shuttle 16 is driven to open and shut without exceeding the scope of screen module 11 and the body 12. In the conventional technology, a protrusion inside the linkage rail is used to make the linkage push the shuttle to move and achieve the constrained motion mechanism. However, when a dead point is reached, a rivet in the rail should overstride the protrusion to get to another side. After a long time usage, the protrusion may be abraded badly, and the linkage mechanism loses effectiveness or the rail may be distorted.

### BRIEF SUMMARY OF THE INVENTION

A sliding type handheld mobile device disclosed in the invention includes a body, a screen module, a shuttle and a linkage. A plurality of keys are disposed on a side surface of the body, and the screen module is electrically connected to the body using a flexible printed circuit (FPC). The surface of a bottom has an opening to allow the FPC to pass through. When the electronic device is not used, the screen module covers on the body and the keys to make the slide type mobile phone have a minimum volume. The screen module also may slide relative to the body to expose the keys and allow a user to use.

The shuttle is used to cover the opening of the screen module, and a cam-shaped track is disposed on the shuttle to dispose the linkage. Another end of the linkage is connected to the body. When the screen module slides relative to the body, the linkage is driven by the body to push the shuttle to slide and cover the opening. The linkage also may slide along to the cam-shaped track to allow the body to stretch totally relative to the screen module and make the keys exposed.

In another aspect, the screen module has a sliding way to allow the linkage to pass through. The sliding way is substantially parallel with the sliding direction of the screen module relative to the body, and it drives the linkage to push the shuttle to move toward the direction to cover the opening. Via the design of the cam-shaped track, the design of a constraining motion mechanism is achieved, and the FPC or elastic elements in the opening of the screen module are not exposed.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the sliding type mobile phone in the conventional technology;

FIG. 2 is a schematic diagram showing the sliding state of the sliding type mobile phone in the conventional technology;

FIG. 3 is a schematic diagram showing the sliding type handheld mobile device;

FIG. 4 and FIG. 5 are schematic diagrams showing the sliding states of the sliding type handheld mobile device, and in FIG. 4 and FIG. 5, the screen module slides relative to the body and exposes the keys; and

FIG. 6 and FIG. 7 are schematic diagrams showing the sliding state of the sliding type handheld mobile device, and in FIG. 6 and FIG. 7 the screen module slides relative to the body and covers the keys.

### DETAILED DESCRIPTION OF THE EMBODIMENTS

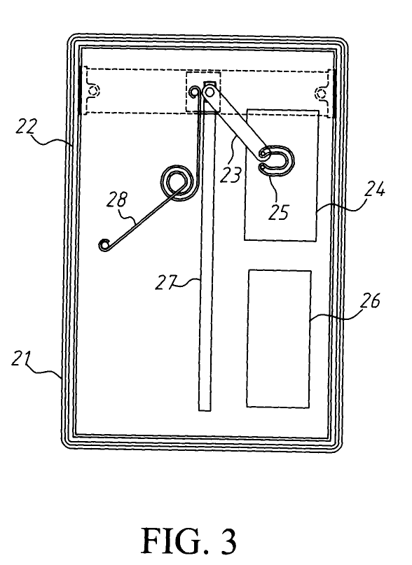

FIG. 3 is a schematic diagram showing a sliding type handheld mobile device according to an embodiment of the invention.

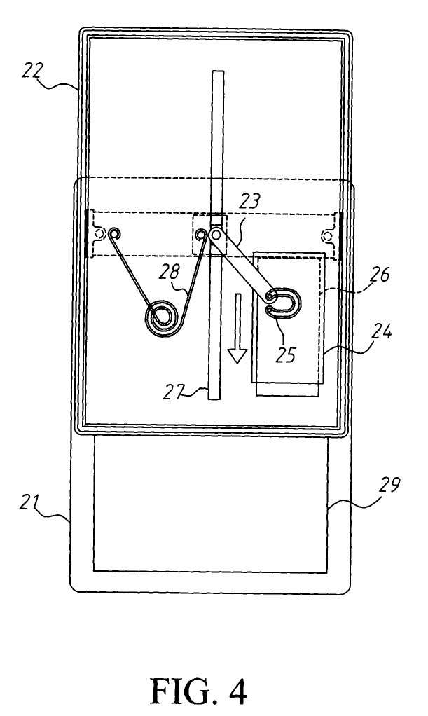

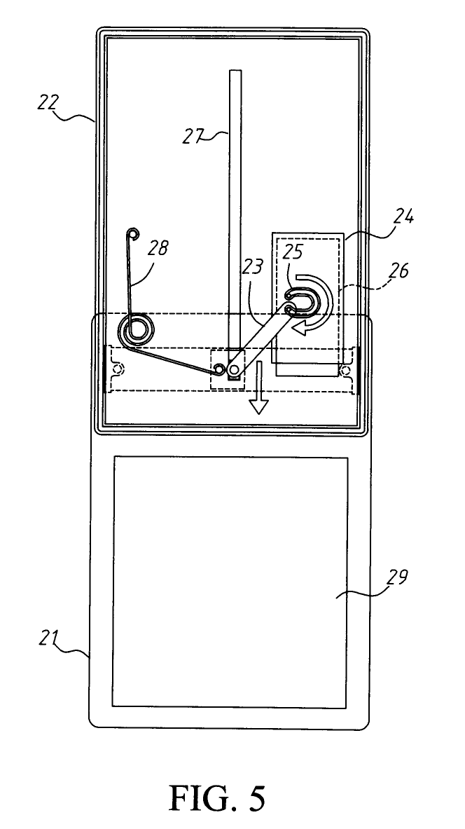

As shown in FIG. 3, the sliding type handheld mobile device includes a body 21, a screen module 22, a shuttle 24 and a linkage 23. The body 21 includes a plurality of keys 29 (as shown in FIG. 4), and the screen module 22 covers the surface of the body 21 to shield the keys 29 and make the whole structure have a minimum volume. Thus, the user may store the sliding type handheld mobile device easily. The screen module 22 may move relative to the body 21 to expose the keys 29 (as shown in FIG. 4 and FIG. 5) and allow the user to use. Since the technology about the sliding mechanism allowing the screen module 22 to slide relative to the body 21 is already mature, and a skilled person in the art may achieve or replace it easily, it is not illustrated herein for a concise purpose.

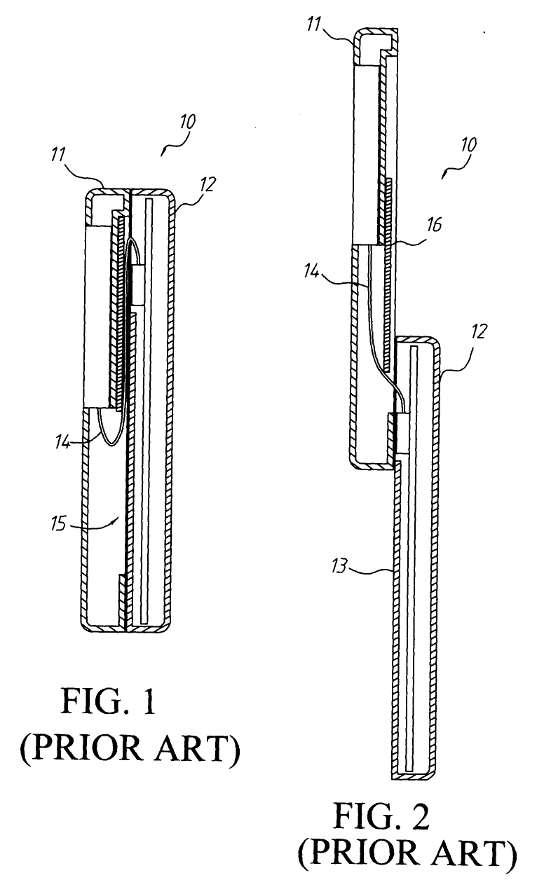

The screen module 22 is electrically connected to the body 21 using a connecting unit 14 passing through the opening 26. The connecting unit 14 may be a flexible printed circuit (FPC) (as shown in FIG. 1 and FIG. 2), a cable or a wire. The shuttle 24 is disposed at a side of the opening 26 and has a cam-shaped track 25 thereon. An end of the linkage 23 is assembled at the cam-shaped track 25, and the other end passes through a sliding way 27 of the screen module 22 to be connected to the body 21.

FIG. 4 and FIG. 5 are schematic diagrams showing the open state of the sliding type handheld mobile device.

As shown in FIG. 4 and FIG. 5, when the screen module 22 slides relative to the body 21, the screen module 22 slides upward. Since one end of the linkage 23 is connected to the body 21, the end is constrained by the body 21 and moves relative to the sliding way 27. Since the sliding way 27 is parallel with the sliding direction of the screen module 22 relative to the body 21, as shown in FIG. 4 and FIG. 5, the direction is substantially vertical, and the linkage 23 slides along the sliding way 27 downward.

The other end of the linkage 23 is disposed in the cam-shaped track 25. Due to the special design of the cam-shaped track 25, when the linkage 23 is pushed at the beginning, the linkage 23 would not move relative to the cam-shaped track 25, and the linkage 23 pushes the shuttle 24 to move downward to cover the opening 26 until shuttle 24 reaches the limit position. At that moment, the keys 29 are not totally exposed (as shown in FIG. 4). The cam-shaped track 25 is formed by protruding from the shuttle 24 in FIG. 4, and the cam-shaped track also may be formed by making a through slot.

Then, the screen module 22 continues moving relative to the body 21, and the linkage 23 is still driven by the body 21 to move downward. Since the shuttle 24 reaches the limit position, the other end of the linkage 23 may slide along the cam-shaped track 25. As shown in FIG. 5, the position of the shuttle 24 does not change, and since the linkage 23 moves to the other end relative to the cam-shaped track 25, to make the linkage 23 slide along the cam-shaped track 25 smoothly, the length of the linkage 23 should be equal to the maximum distance between the sliding way 27 and the cam-shaped track 25.

With the sliding of the linkage 23 relative to the cam-shaped track 25, the screen module 22 and the body 21 move continuously, and the keys 29 of the body 21 are totally exposed. At that moment, although part of the opening 26 is not covered by the shuttle 24, since the part is at the place where the body 21 and the screen module 22 are overlapped, the connecting unit such as the FPC and electronic elements inside the opening 26 are not exposed. Thus, via the design of the cam-shaped track 25, the whole linkage mechanism presents a constrained motion, and the shuttle 24 is driven by the linkage 23 and covers the opening 26.

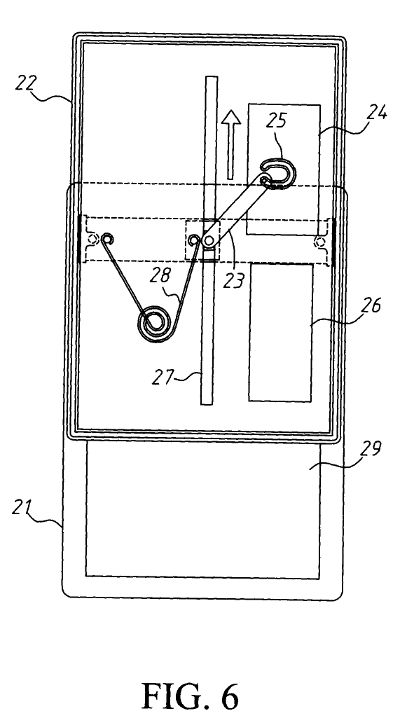

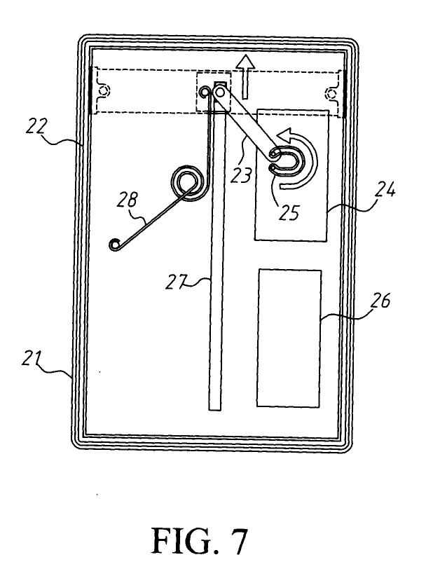

FIG. 6 and FIG. 7 are schematic diagrams showing the shut state of the sliding type handheld mobile device.

The body 21 and the screen module 22 further include an elastic element 28. An end of the elastic element 28 is connected to the body 21, and the other end is connected to the screen module 22. As shown in FIG. 6 and FIG. 7, the elastic element 28 is a torsional spring, and it also may be replaced by other springs such as extension springs and compression springs.

Thus, when the user wants to close the sliding type handheld mobile device, he or she only has to push the body 21 or the screen module 22 to generate an initial restoring force, and the elastic element 28 may provide a restoring force continuously to make the screen module 22 slide relative to the body 21 downward. Since one end of the linkage 23 is connected to the body 21, it may be driven to slide upward along the sliding way 27. The other end is disposed in the cam-shaped track 25 of the shuttle 24, and the cam-shaped track 25 is designed to be symmetric. Thus, when the linkage slides at the beginning, the linkage 23 does not move relative to the cam-shaped track 25, and it only pushes the shuttle 24 to move upward (as shown in FIG. 6) until the shuttle 24 reaches the highest position.

Then, similarly, the screen module 22 and the body 21 move continuously. Since the shuttle 24 cannot be moved, the linkage 23 is driven by the body 21 continuously to slide along the cam-shaped track 25. As shown in FIG. 7, the screen module 22 and the body 21 go back to an overlapping state.

In the sliding type handheld mobile device disclosed in the invention, due to the special design of the cam-shaped track of the shuttle, the linkage do not move relative to the cam-shaped track when it is driven by the linkage at the beginning. Only the shuttle is pushed to cover the opening of the screen module. When the shuttle moves to a limit position, the linkage slides to the other end along the cam-shaped track to make the screen module and the body stretch totally to expose the keys. Thus, the cam-shaped track is utilized effectively to make the linkage mechanism have the constrained motion and make the shuttle slide with the screen module and the body to cover the opening. This also prevents electronic elements inside the opening of the screen module or the electrically connected FPC from being exposed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A sliding type handheld mobile device, comprising:
a body having a plurality of keys disposed on a surface of the body;
a screen module having a bottom, wherein the bottom has an opening and covers the keys to allow the screen module to be stacked with the body;
a connecting unit having two ends, one end electrically connected to the body and another end passing through the opening to be electrically connected to the screen module;
a shuttle having a cam-shaped track; and
a linkage having two ends, one end connected to the body and another end connectedly disposed at the cam-shaped track of the shuttle;
wherein when the screen module slides relative to the body, the linkage is driven by the body to push the cover to slide, the shuttle further covers the opening, and when the linkage slides along the cam-shaped track, the body slides relative to the screen module to expose the keys totally.

2. The sliding type handheld mobile device according to claim 1, wherein the connecting unit is a flexible printed circuit (FPC).

3. The sliding type handheld mobile device according to claim 1, wherein the screen module has a sliding way for allowing one end of the linkage to be disposed to connect the screen module to the body.

4. The sliding type handheld mobile device according to claim 3, wherein the sliding way is parallel with a sliding direction of the body and the screen module.

5. The sliding type handheld mobile device according to claim 3, wherein a length of the linkage equals to the distance between the sliding way and the center of the cam-shaped track.

6. The sliding type handheld mobile device according to claim 1, wherein the shuttle is protrudent to form the cam-shaped track.

7. The sliding type handheld mobile device according to claim 1, wherein the shuttle has a through slot to form the cam-shaped track.

8. The sliding type handheld mobile device according to claim 1, further comprising an elastic element having two ends, one end connected to the body and another end connected to the screen module.

9. The sliding type handheld mobile device according to claim 8, wherein the elastic element is a torsional spring.
